(19) United States
(12) Patent Application Publication
(10) Pub. No.: US 2022/0026316 A1
(43) Pub. Date: Jan. 27, 2022

(54) Apparatus and Method for Dislodging and Capturing Sample from Cotton Bale

(71) Applicant: Rethceif Enterprises, LLC, Ossian, IN (US)

(72) Inventors: Briar Lee Gerber, Fort Wayne, IN (US); Jason M. Knueven, Sunman, IN (US); Philip R. Beer, Craigville, IN (US); Chris Allen Honegger, Bluffton, IN (US)

(73) Assignee: Rethceif Enterprises, LLC, Ossian, IN (US)

(21) Appl. No.: 17/385,151

(22) Filed: Jul. 26, 2021

Related U.S. Application Data
(60) Provisional application No. 63/057,137, filed on Jul. 27, 2020.

(51) Int. Cl. G01N 1/14; G01N 1/04

(52) U.S. Cl. CPC G01N 1/14; G01N 1/04

(57) ABSTRACT

An apparatus and method for dislodging a cotton sample from a side surface of a cotton bale includes an air nozzle fluidly connected to a supply of pressurized air. Conveyors and/or a ram transport the bale adjacent the nozzle. A quick release valve in line between the nozzle and the supply of pressurized air is selectively openable for directing a burst of air through the air nozzle to the side surface of the bale and thereby dislodging a cotton sample from the bale side surface. A sample intake opening is located adjacent the bale side surface and below the air nozzle. An air vacuum is fluidly connected to the sample intake opening whereby the dislodged cotton sample is sucked into the intake opening and transported to a sample collection receptacle.

### CROSS REFERENCE TO RELATED APPLICATIONS

This application claims priority under 35 U.S.C. 119(e) of U.S. provisional patent application Ser. No. 63/057,137 filed on Jul. 27, 2020 entitled Apparatus and Method for Dislodging and Capturing Sample from Cotton Bale, the disclosure of which is hereby incorporated herein by reference.

### BACKGROUND OF THE INVENTION

### 1. Field of the Invention

The present invention relates to the field of apparatus and methods for taking samples from bales of bulk material. More particularly, the present invention relates to the field of dislodging and capturing samples from cotton which has been previously baled.

### 2. Background

Apparatus for dislodging and capturing samples from bales of cotton have heretofore been devised and used. For example, Actis, U.S. Pat. Nos. 8,336,404 and 8,746,087, and Hart, U.S. Pat. No. 9,599,544, disclose finger gripping mechanisms which grasp the sample from the side of a bale and pull and dislodge it therefrom. The gripping mechanism then releases the dislodged sample for transport with a mechanism, such as a vacuum tube delivery system, to a remote location whereat the sample can be processed as needed.

Although the prior sample dislodging and capturing apparatus function adequately for their intended purpose, they tend to be complex and, consequently, relatively costly mechanisms. Moreover, the operation of extending the arm carrying the finger gripping mechanism towards and to the side surface of the bale, actuating the fingers for grasping the sample, retracting the arm away from the bale and dislodging the sample therefrom, and finally withdrawing the fingers for releasing the sample is substantially time consuming.

Accordingly, a need exists for a more efficient, relatively less costly and quicker apparatus and method for dislodging and capturing samples from bales of cotton.

### SUMMARY OF THE INVENTION

The present invention overcomes the disadvantageous of prior apparatus and methods used for dislodging and capturing cotton samples from bales of cotton.

In one form thereof, the present invention is directed to a method of dislodging a cotton sample from a bale of cotton by: locating the bale of cotton adjacent an air nozzle; providing pressurized air to the air nozzle; and, directing a burst of air to a side surface of the bale of cotton and thereby dislodging a cotton sample therefrom.

Preferably, the dislodged cotton sample is captured by providing a vacuum intake opening adjacent the side surface of the bale of cotton and providing an air vacuum thereto whereby the dislodged cotton sample is sucked into the vacuum intake opening. The captured dislodged cotton sample is delivered from the vacuum intake opening, through a conduit, to a collection receptable by providing the air vacuum at the collection receptacle. Further preferably, prior to directing a burst of air to the side surface of the bale of cotton, the side surface of the bale is sliced along a pair of adjacent lines whereby the cotton sample is defined therebetween and remains intact with the bale.

A second air nozzle can be provided adjacent the bale side surface. Pressurized air is also provided to the second air nozzle and a burst of air is directed from also the second nozzle to the side surface of the bale of cotton for thereby dislodging the cotton sample therefrom.

Additionally, during the step of locating, a second side surface of the bale of cotton can be located adjacent a third air nozzle. Pressurized air is provided to the third air nozzle for thereby directing a burst of air to the second side surface of the bale of cotton and thereby dislodging a second cotton sample therefrom.

In another form thereof, the present invention is directed to an apparatus for dislodging a cotton sample from a bale of cotton. The apparatus includes: a carrying surface supporting the bale of cotton; an air nozzle adjacent a side surface of the bale; and, a supply of pressurized air fluidly connected to the air nozzle whereby, by directing a burst of air through the air nozzle to the side surface of the bale of cotton, a cotton sample is dislodged from the bale of cotton side surface.

The carrying surface can be a conveyor whereby the bale of cotton may be transported to adjacent the air nozzle. Alternatively, a longitudinally moveable ram can be provided and adapted to contact and transport the bale of cotton along the carrying surface to adjacent the air nozzle.

A valve can be provided in line between the supply of pressurized air and the air nozzle. The valve is selectively openable for providing the burst of air through the air nozzle. The valve can be a solenoid valve or, preferably, a high volume quick release solenoid valve.

The apparatus can include a sample intake conduit including a conduit intake opening; a sample collection receptable fluidly connected to the sample intake conduit. An air vacuum is provided at the collection receptable whereby the dislodged cotton sample is sucked into the sample intake conduit through the opening thereof and is delivered to the collection receptacle

Preferably, the apparatus includes a funnel and air nozzle carrying assembly including a lower chassis defining a sample intake opening and an upper nozzle carrying arm. The air nozzle is secured to and supported by the upper nozzle carrying arm. An air vacuum is fluidly connected to the sample intake opening whereby a cotton sample dislodged from the bale of cotton can be sucked into the sample intake opening. A sample collection receptable can be fluidly connected to the sample intake opening and the air vacuum can be provided at the collection receptable whereby the dislodged cotton sample can be sucked into the sample intake conduit and delivered to the collection receptacle.

The nozzle can be pivotally secured to the nozzle carrying arm whereby the direction of the burst of air can be selectively adjustable.

The apparatus can further include a second air nozzle adjacent a second side surface of the bale; a second funnel and air nozzle carrying assembly comprising a second lower chassis defining a second sample conduit opening and a second upper nozzle carrying arm. The second air nozzle is secured to and supported by the second upper nozzle carrying arm. An air vacuum is fluidly connected to the second sample intake conduit opening whereby a cotton sample dislodged from the second side surface of bale of cotton can be sucked into the second sample intake conduit.

### BRIEF DESCRIPTION OF THE DRAWINGS

The above mentioned and other features and objects of this invention, and the manner of attaining them, will become more apparent and the invention itself will be better understood by reference to the following description of the embodiments of the invention taken in conjunction with the accompanying drawings, wherein:

FIG. 1A is a perspective view of a cotton bale sampling and bagging machine constructed in accordance with the principles of the present invention;

FIG. 1B is a side elevation view of the cotton bale sampling and bagging machine shown in FIG. 1A;

FIG. 2 is a perspective view of the machine and taken from the same angle as FIG. 1A but wherein the bagging station, the ram assembly and other parts of the machine have been removed for thereby showing the bale sampling apparatus as constructed in accordance with the principles of the present invention and diagrammatically further showing a supply of pressurized air fluidly connected to the air nozzles and a vacuum duct fluidly connected to the sample intake conduit/funnel;

FIG. 3 is a diagrammatic cross section view of the bale sampling apparatus similar to FIG. 2 and taken generally along line 3-3 in FIG. 1B;

FIG. 4A it is a diagrammatic perspective view similar to FIG. 2 but wherein only one of the funnel and air nozzle carrying assemblies and vacuum duct are shown together with a bale of cotton wherein the bale side surface has been sliced thereby defining the samples, but wherein the samples remain intact with the bale;

FIG. 4B is a diagrammatic perspective view similar to FIG. 4A but showing the bale side surface after one of the samples has been dislodged therefrom;

FIG. 5 is a perspective view of a funnel and air nozzle carrying assembly of the bale sampling apparatus shown in FIG. 2;

FIG. 6 is another perspective view of the funnel and air nozzle carrying assembly shown in FIG. 5;

FIG. 7 is a front elevation view of the funnel and air nozzle carrying assembly shown in FIG. 5;

FIG. 8 is a cross section view of the funnel and air nozzle carrying assembly shown in FIG. 5 and taken generally along line 8-8 in FIG. 7;

FIG. 9 is a perspective view of the funnel and air nozzle carrying assembly similar to FIG. 6 with the components thereof shown exploded;

FIG. 10 is a side elevation view of the funnel and air nozzle carrying assembly shown in FIG. 5 with the components thereof shown exploded;

FIG. 11 is a cross section view similar to FIG. 8 but depicting another embodiment of the funnel and air nozzle carrying assembly;

FIG. 12 is a cross section view similar to FIG. 8 but depicting yet another embodiment of the funnel and air nozzle carrying assembly;

FIG. 13 is a perspective view of a cotton bale sampling and bagging machine constructed in accordance with the principles of the present invention and incorporating another embodiment of a bale sampling apparatus constructed in accordance with the principles of the present invention;

FIG. 14 is a side elevation view of the funnel and air nozzle carrying assembly of the bale sampling apparatus shown in FIG. 13;

FIG. 15A is a perspective view of another embodiment of a nozzle utilized in the bale sampling apparatus constructed in accordance with the principles of the present invention and with its side plates removed; and,

FIG. 15B it is a perspective view of the nozzle shown in FIG. 15A but with the side plates fixedly secured thereto.

Corresponding reference characters indicate corresponding parts throughout several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION OF THE PREFERRED EMBODIMENTS

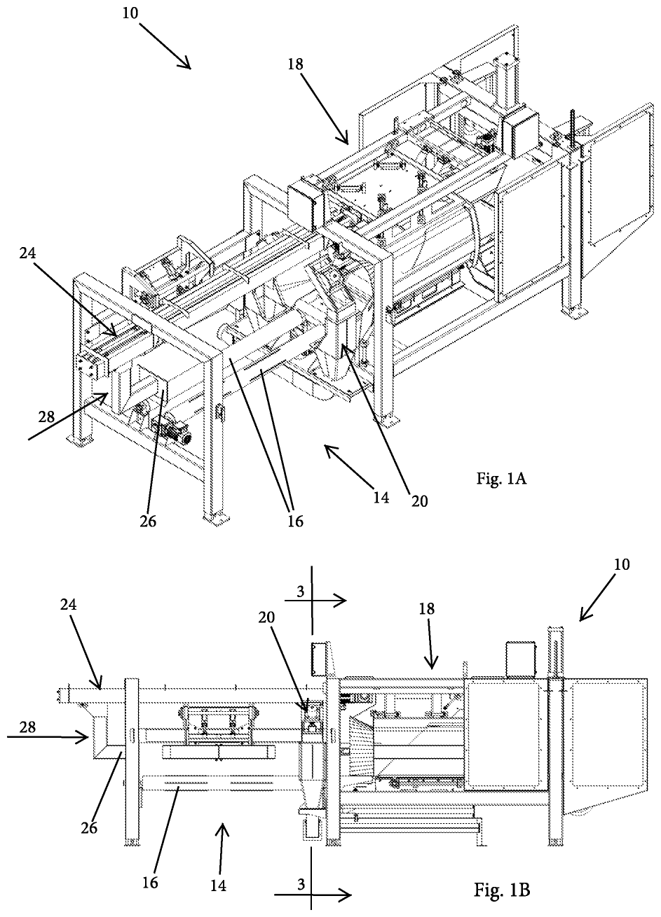

Referring initially to FIGS. 1A and 1B, there is shown and generally designated by the numeral 10, a machine for wrapping/bagging bulk material, such as cotton, which has previously been baled into a cuboid shape. A cuboid shape bale of cotton is, for example, shown in the drawings and generally designated by the numeral 12. Machine 10 includes an intake area 14 whereat cotton bales 12 are placed on a rollers conveyor 16, and a wrapping/bagging station 18 whereat the cotton bales 12 are wrapped with plastic film and/or inserted into a plastic film bag.

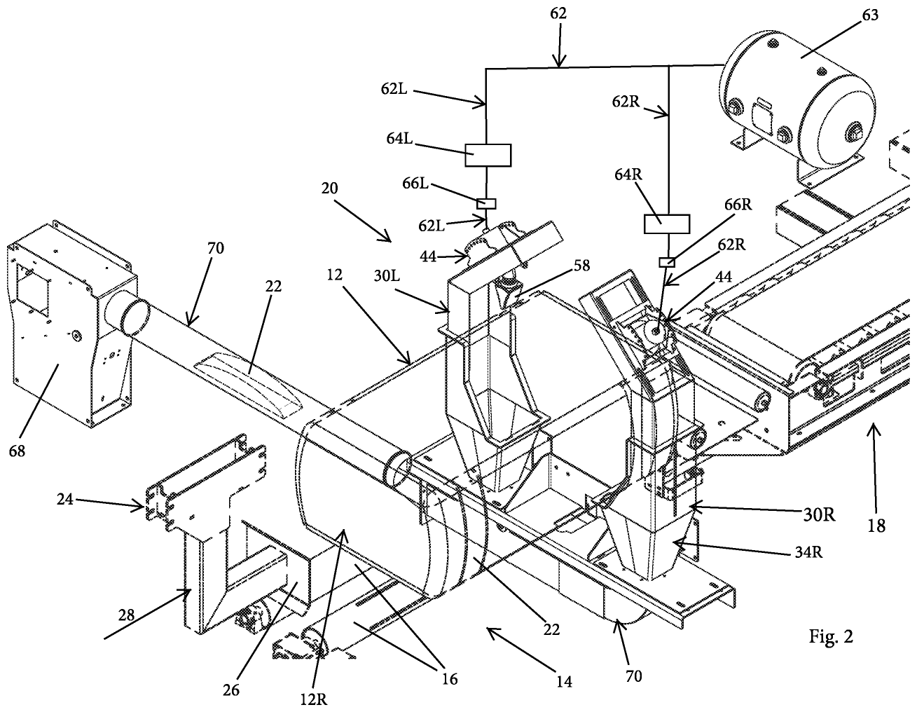

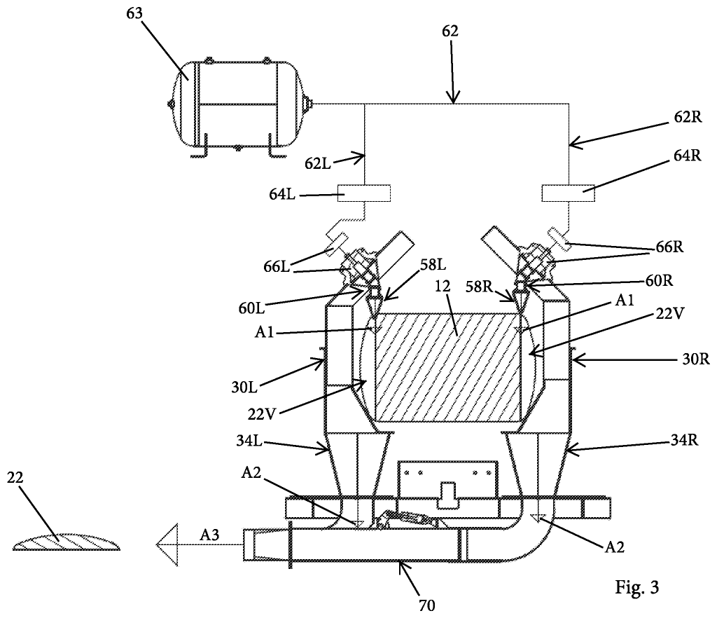

A sampling apparatus/station constructed in accordance with the principles of the present invention and generally designated by the numeral 20 is incorporated into the machine 10 for dislodging and capturing cotton samples 22 (FIG. 3 and shown in dash lines in FIG. 2) from the cotton bales 12, preferably just prior to/before the bales 12 enter the wrapping/bagging station 18. A ram assembly 24 is provided and includes a ram head 26 adapted to make contact with the rear end surface 12R of the cotton bale 12 and push the bale, in the direction indicated by arrow 28, longitudinally through the sampling apparatus/station 20 and into the wrapping/bagging station 18. Of course, it is contemplated that the sampling apparatus 20 can be incorporated into other types of machines and/or can be constructed as a standalone unit together with a conveyor means such as the rollers conveyor 16 and ram assembly 24 and/or other conveyors capable of carrying and transporting the cotton bales 12 to and through the sampling apparatus 20.

The sampling apparatus 20 includes at least one, but preferably two, funnel and air nozzle carrying assemblies generally designated by the numeral 30. A right funnel and air nozzle carrying assembly 30R is provided on the right-hand side of the rollers conveyor 16, and a left funnel and air nozzle carrying assembly 30L is provided on the left-hand side of the rollers conveyor 16. Assemblies 30R and 30L can be located generally in the same plane/facing each other as shown in the drawings, or offset from each other longitudinally along the travel path of the cotton bale 12 which is depicted by arrow 28. Assemblies 30 can include a lower chassis 32 defining/forming a conduit/funnel 34 having a sizable conduit/funnel intake opening 34O and an smaller exit opening 34E. The lower chassis 32 can further define/form, at its upper end, a generally vertically extending U-shaped slide channel 36.

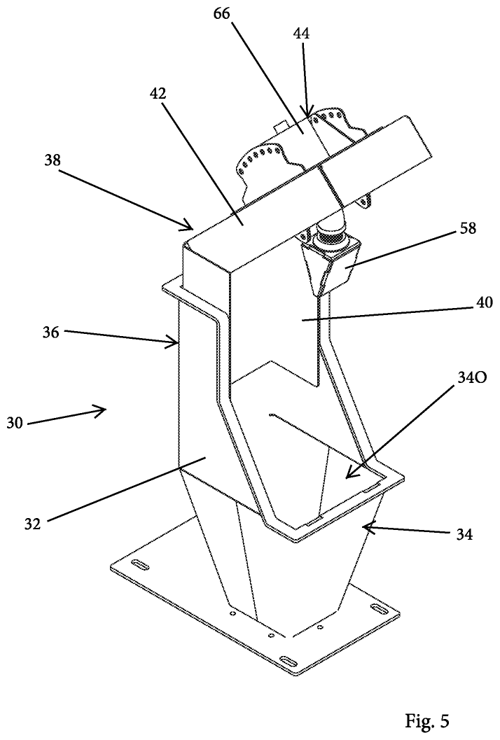

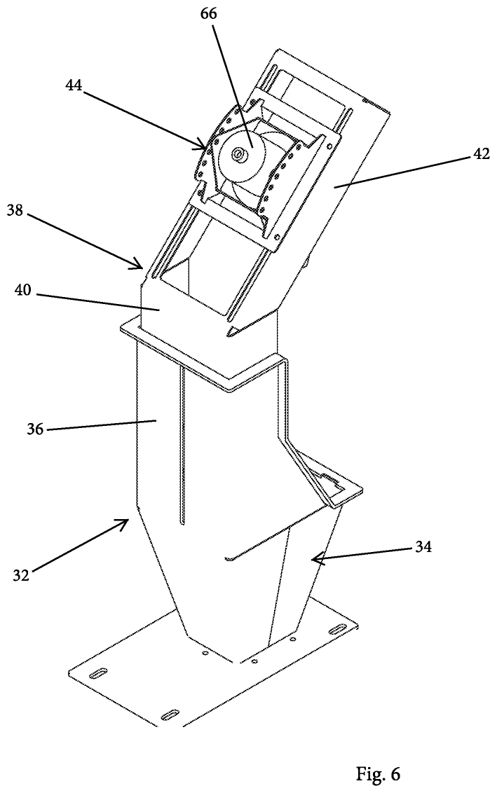

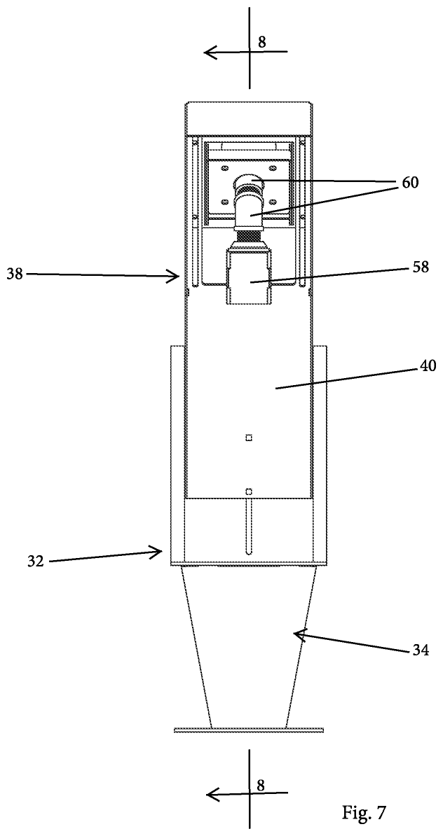

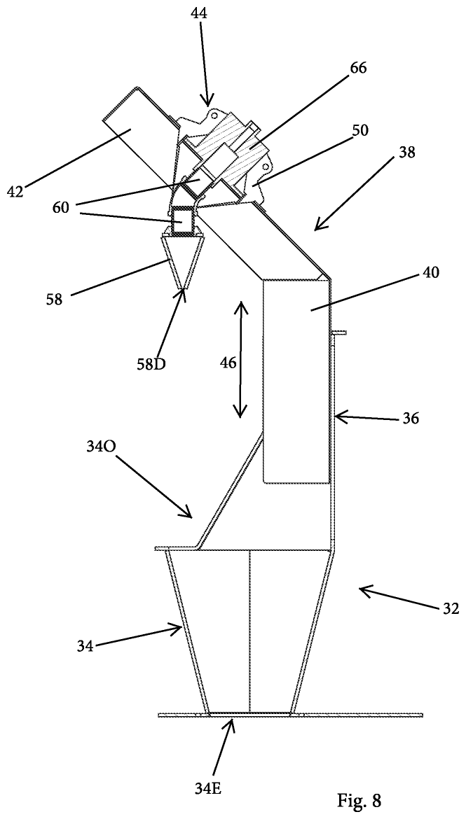

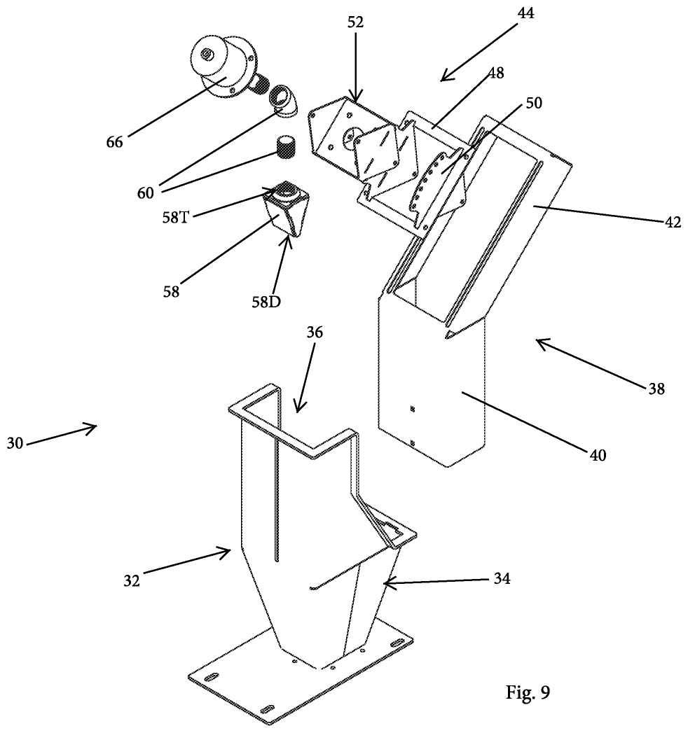

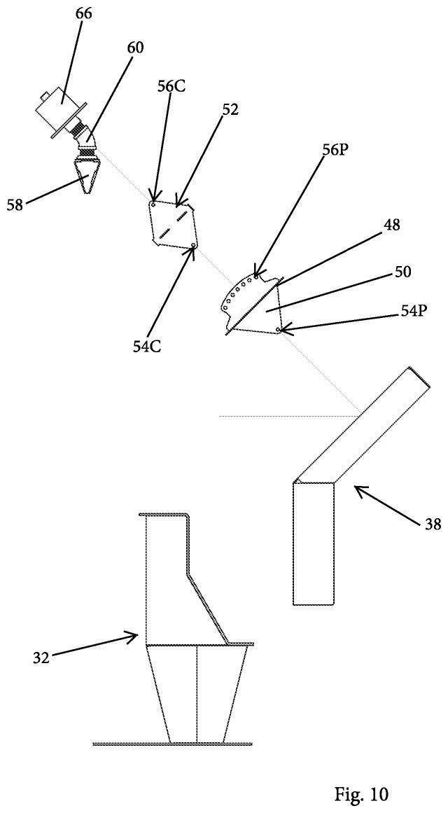

Assemblies 30 can further include an upper nozzle carrying arm 38 defining/forming a boom portion 40 and a nozzle carrying bracket 42 extending at about a 45° angle from the boom portion 40, as depicted in the embodiment of FIGS. 1-10. The boom portion 40 is slidably and selectively fixedly received within the U-shaped slide channel 36 of the lower chassis 32. The bracket 42 is adapted to mount thereon and carry a directional air nozzle assembly 44. Accordingly, the upper nozzle carrying arm 38 and the directional air nozzle assembly 44 mounted thereon are selectively vertically adjustable relative to the lower chassis 32, as indicated by arrows 46, by sliding and selectively fixing the boom portion 40 within the U-shaped channel 36 with fasteners (not shown).

The directional air nozzle assemblies 44 include a collar 48 adapted to be mounted to the nozzle carrying bracket 42 and supporting a pair of plates 50. Plates 50 are generally parallel to one another and define an opening therebetween adapted to receive a nozzle carriage 52 therein. Plates 50 are provided with pivot holes 54P and directional securement holes 56P. The nozzle carriage 52 is provided with pivot holes 54C and directional securement holes 56C. The nozzle carriage 52 is pivotally secured to the plates 50 with fasteners (not shown) extending through aligned pivot holed 54P and 54C and thereby pivots thereabout. After the nozzle carriage 52 is pivoted to a desired pivot position/angle, nozzle carriage 52 can be fixedly secured at that desired position/angle with fasteners (not shown) extending through directional securement holes 56P, 56C.

An air nozzle 58 is mounted to and is carried by the nozzle carriage 52. Nozzle 58 includes an upstream threaded opening 58T for fluidly connecting the nozzle, via couplings or other suitable similar means 60, to a flexible air supply line/hose 62. Nozzle 58 further includes a downstream discharge opening 58D. The discharge opening 58D can take many different forms and shapes as may be needed for most efficiently dislodging the samples 22 from the bales 12 as more fully described hereinbelow. For example, discharge opening 58D can be circular or rectangular. Preferably, discharge opening 58D is rectangular shaped having a length which is substantially longer than its width as shown in the drawings. Accordingly, by fluidly connecting the nozzle 58 to the flexible air supply line/hose 62 and mounting the nozzle on the pivotable nozzle carriage 52, the air nozzle 58 is selectively fixedly pivotable about the pivot holes 54P of plates 50 for directing the air nozzle discharge opening 58D in a desired direction/at a desired angle. The air nozzle 58 is generally vertically aligned with the funnel intake opening 34O of the lower chassis 32.

Referring now to FIGS. 2 and 3, a pressurized air supply (not shown) and tank 63 are provided and are fluidly connected to the nozzles 58L, 58R via the respective air lines/hoses 62L, 62R and a common air line/hose 62. Solenoid or manual air valves 64L, 64R are provided in-line/in the respective air supply lines/hoses 62L, 62R between the air tank 63 and the respective nozzles 58L, 58R. Quick exhaust/release valves 66L, 66R are provided in-line/in the respective air supply lines/hoses 62L, 62R between the respective solenoid/manual valves 64L, 64R and the respective nozzles 58L, 58R. The solenoid/manual valves 64L, 64R can be used to control when and the rate at which pressurized air is supplied therethrough and to the respective quick exhaust/release valves 66L, 66R. The quick exhaust/release valves 66L, 66R are capable of quickly releasing a large volume/a burst of pressurized air therethrough and to the respective nozzles 58L, 58R. Quick exhaust/release valves 66 can, for example, be those which are commercially available under the trade name “Mini-B-Air Blaster” available from VIBCO Vibrators, 75 Stilson Road, Wyoming, R.I. 02898.

In an alternate embodiment, the quick exhaust/release valves 66L, 66R can be eliminated and high flow type solenoid/manual valves 64L, 64R can be used for quickly releasing the large volume/burst of pressurized air therethrough and to the respective nozzles 58L, 58R.

With continued reference to FIGS. 2 and 3, the funnel exit opening 34E of the lower chassis funnels 34 are fluidly connected to an air duct 70. A vacuum source (not shown) and a sample collection receptacle 68 are provided and are fluidly connected to the duct 70, in a known and customary manner, for providing a vacuum in the duct 70 and sucking/drawing samples 22 into the funnels 34L, 34R through their respective funnel intake openings 340, then into the duct 70 through their respective funnel exit openings 34E, and finally through the duct 70 and into the receptacle 68. An operator can, thereafter, remove the sample 22 from the receptacle 68 for processing the sample as needed or desired.

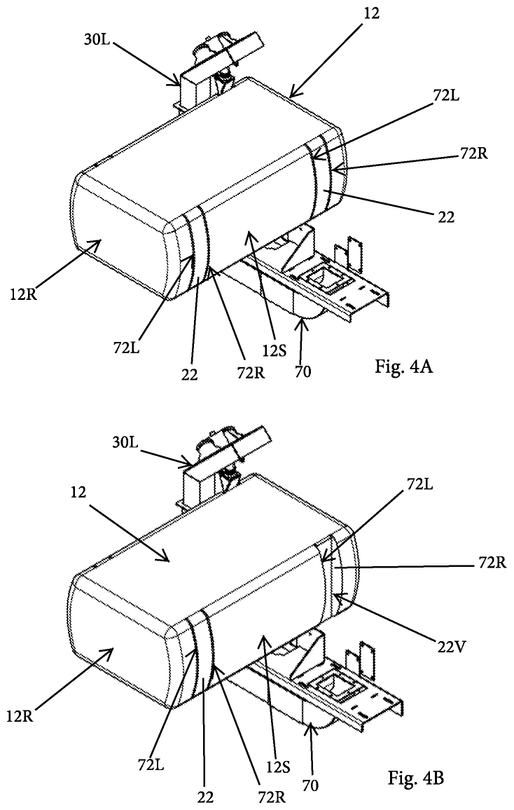

In operation, for dislodging the samples 22 from a bale 12, the bale is typically preferably, although not necessarily, cut/sliced at the side surfaces 12S thereof along vertical cut/slice lines 72L, 72R whereby the sample 22 remains intact with the bale between the cut/slice lines 72L, 72R. The bale 12 is then transported using the rollers conveyor 16 and ram assembly 24, and/or with other types of conveyors, longitudinally in the direction of arrow 28 to a position between the funnel and air nozzle assemblies 30L, 30R, as shown in FIGS. 2 and 3. In this position, the sample 22 which is still intact with the bale 12 is generally vertically aligned between a nozzle 58 and the funnel intake opening 34O there below. The respective quick exhaust/release valve 66 is then energized causing a large volume/a burst of pressurized air to be directed through the nozzle 58 towards and onto the intact sample 22, as depicted by arrows A1 in FIG. 3, thereby causing the sample 22 to be separated/dislodged from the bale 12. Preferably simultaneously, a vacuum/suction is provided at the funnel intake opening 34O whereby the dislodged sample 22 will be sucked/drawn into the funnel 34 and delivered to the duct 70 (as depicted by arrows A2), and then through the duct 70 (as depicted by arrow A3), and will be delivered to the sample collection receptacle 68. After the sample 22 has been dislodged from the bale 12, the bale side surface will, of course, be left with a void as diagrammatically shown and depicted by the numeral 22V in FIGS. 3 and 4A.

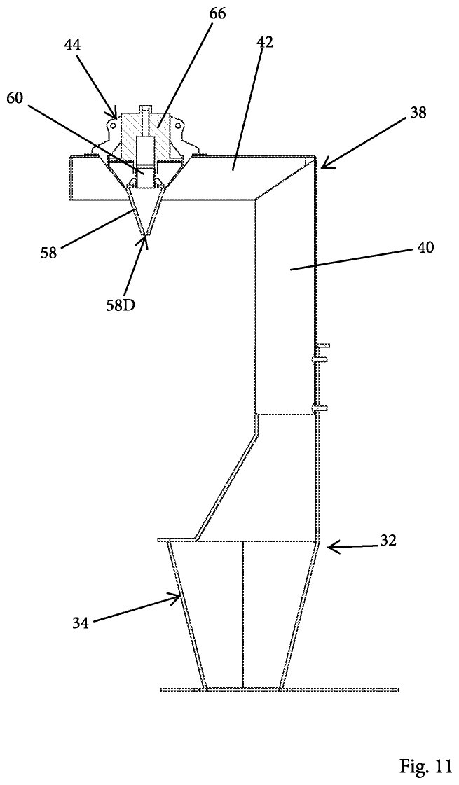

In the embodiment of FIG. 11, the nozzle carrying bracket 42 of the upper nozzle carrying arm 38 extends from the boom portion 40 at about a 90° angle whereby the nozzle 58 thereof can more readily be located above the bale 12 and the blast of air better directed atop the intact sample 22 and towards the funnel intake opening 34O.

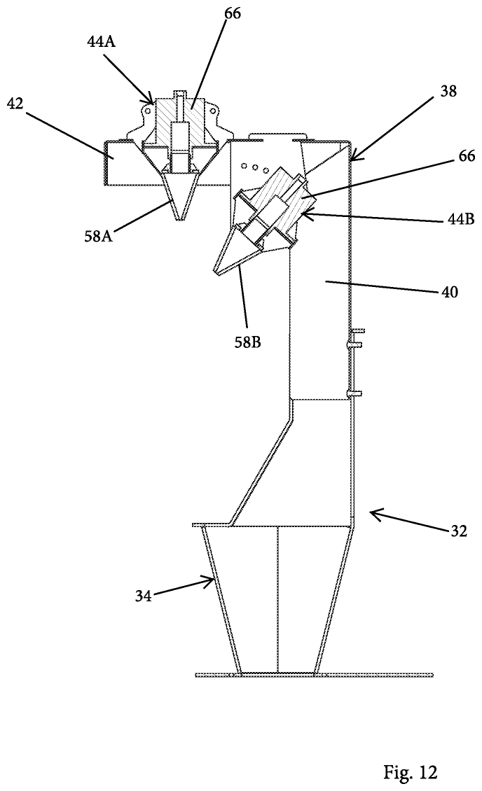

In the embodiment of FIG. 12, a pair of directional air nozzle assemblies 44A, 44B are provided on upper nozzle carrying arm 38. Nozzle assembly 44A supports and directs its nozzle 58A generally vertically downwardly similar to the embodiments described hereinabove and shown in FIGS. 1-11. Nozzle assembly 44B, however, supports and directs its nozzle 58B generally at a 45° angle downwardly and towards the bale side surface 12S. The bursts of pressurized air through the nozzles 58A, 58B can be provided simultaneously or sequentially, as may be needed, for more efficiently and effectively dislodging the sample 22 from the bale 12 and directing it towards the funnel intake opening 34O.

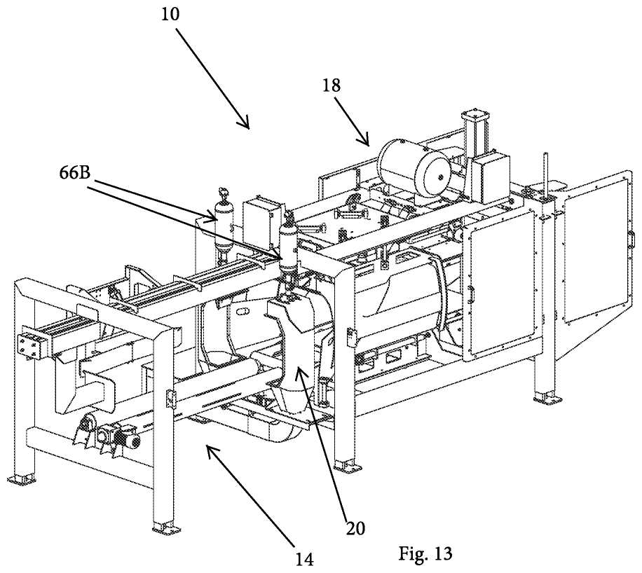

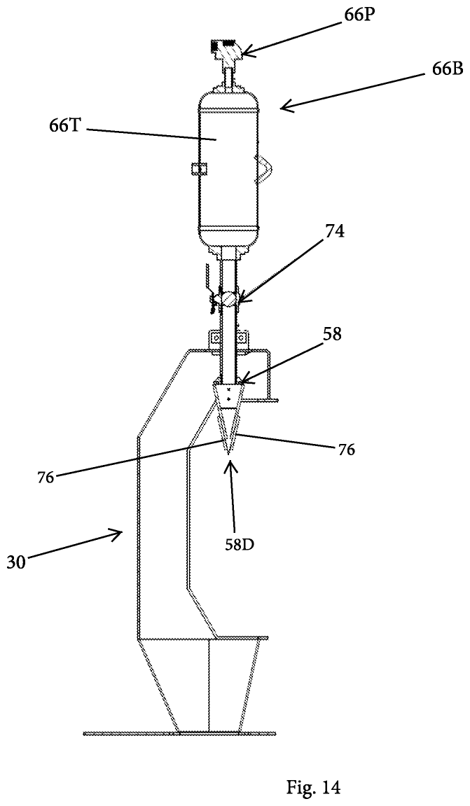

Referring now more particularly to FIGS. 13 and 14, the embodiment shown therein is substantially similar to that described hereinabove except that, instead of utilizing a “Mini-B-Air Blaster”, the quick exhaust/release valve shown and generally designated by the numeral 66B is an “ABS-1-1/2-Air Cannon”, also available from VIBCO Vibrators. Quick exhaust valve 66B comprises a larger high-pressure air storage tank 66T and a quick release piston valve 66P whereby a greater volume of compressed air can more quickly be released to the nozzle 58 for thereby more efficiently and better dislodging the sample 22 from the bale 12. A ball valve 78 is provided between the quick exhaust valve 66B and the nozzle 58 for controlling and/or regulating the airflow from the valve 66B to the nozzle 58.

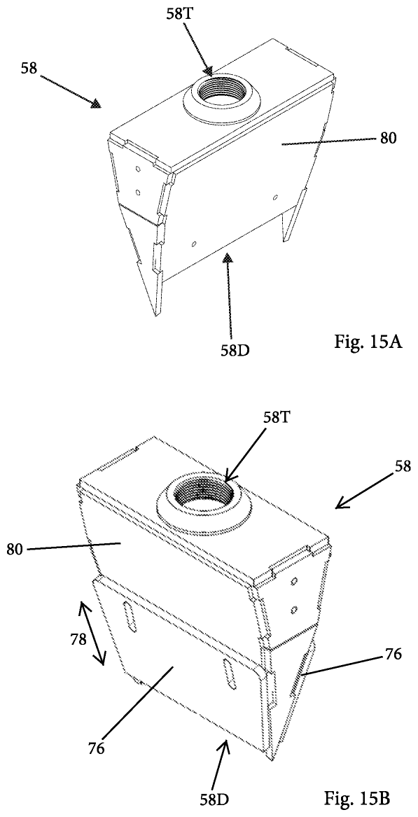

Preferably as shown in FIGS. 15A and 15B, the nozzle 58, includes one or more slide plates 76 selectively slidably adjustable along as indicated by arrows 78 and attachable with fasteners (not shown) to the side walls 80 of the nozzle 58, whereby the width of the nozzle discharge opening 58D can be selectively adjusted for increasing or decreasing the velocity of the burst of air flow therethrough.

While this invention has been described as having an exemplary design, the present invention may be further modified within the spirit and scope of this disclosure. This application is therefore intended to cover any variations, uses, or adaptations of the invention using its general principles.

What is claimed is:

1. A method of dislodging a cotton sample from a bale of cotton comprising the steps of:
locating the bale of cotton adjacent an air nozzle;
providing pressurized air to the air nozzle; and,
directing a burst of air to a side surface of the bale of cotton and thereby dislodging a cotton sample therefrom.

2. The method of claim 1 further comprising the step of capturing the dislodged cotton sample by providing a vacuum intake opening adjacent the side surface of the bale of cotton and providing an air vacuum thereto whereby the dislodged cotton sample is sucked into the vacuum intake opening.

3. The method of claim 2 further comprising the step of delivering the dislodged cotton sample from the vacuum intake opening, through a conduit to a collection receptable by providing the air vacuum at the collection receptacle.

4. The method of claim 1 further comprising, prior to directing a burst of air to the side surface of the bale of cotton, the step of slicing the side surface of the bale along a pair of adjacent lines whereby the cotton sample is defined therebetween and remains intact with the bale.

5. The method of claim 1 further comprising:
during the step of locating, simultaneously locating the bale of cotton adjacent a second air nozzle;
providing pressurized air to the second air nozzle; and,
directing a burst of air to a second side surface of the bale of cotton and thereby dislodging a second cotton sample therefrom.

6. The method of claim 1 further comprising:
during the step of locating, also locating the bale of cotton adjacent a second air nozzle;
providing pressurized air to the second air nozzle; and,
directing a burst of air from also the second nozzle to the side surface of the bale of cotton for thereby dislodging the cotton sample therefrom.

7. An apparatus for dislodging a cotton sample from a bale of cotton comprising:
a carrying surface supporting the bale of cotton;
an air nozzle adjacent a side surface of the bale; and,
a supply of pressurized air fluidly connected to the air nozzle whereby, by directing a burst of air through the air nozzle to the side surface of the bale of cotton, a cotton sample is dislodged from the bale of cotton side surface.

8. The apparatus of claim 7 wherein the carrying surface is a conveyor whereby the bale of cotton may be transported to adjacent the air nozzle.

9. The apparatus of claim 7 further comprising a longitudinally moveable ram adapted to contact and transport the bale of cotton along the carrying surface to adjacent the air nozzle.

10. The apparatus of claim 7 further comprising a valve in line between the supply of pressurized air and the air nozzle whereby the valve is selectively openable for providing the burst of air through the air nozzle.

11. The apparatus of claim 10 wherein the valve is a solenoid valve.

12. The apparatus of claim 10 wherein the valve is a high volume quick release solenoid valve.

13. The apparatus of claim 7 further comprising:
a sample intake conduit including a conduit intake opening; and,
an air vacuum fluidly connected to the sample intake conduit whereby a cotton sample dislodged from the bale of cotton can be sucked into the intake conduit through the opening thereof.

14. The apparatus of claim 7 further comprising:
a sample intake conduit including a conduit intake opening;
a sample collection receptable fluidly connected to the sample intake conduit; and,
wherein the air vacuum is provided at the collection receptable whereby the dislodged cotton sample is sucked into the sample intake conduit through the opening thereof and is delivered to the collection receptacle.

15. The apparatus of claim 7 further comprising:
a funnel and air nozzle carrying assembly comprising a lower chassis defining a sample intake opening and an upper nozzle carrying arm;
wherein the air nozzle is secured to and supported by the upper nozzle carrying arm; and,
an air vacuum fluidly connected to the sample intake opening whereby a cotton sample dislodged from the bale of cotton can be sucked into the sample intake opening.

16. The apparatus of claim 15 further comprising:
a sample collection receptable fluidly connected to the sample intake opening;
wherein the air vacuum is provided at the collection receptable whereby the dislodged cotton sample is sucked into the sample intake conduit and is delivered to the collection receptacle.

17. The apparatus of claim 15 wherein the air nozzle is pivotally secured to the nozzle carrying arm whereby the direction of the burst of air is selectively adjustable.

18. The apparatus of claim 15 further comprising:
a second air nozzle adjacent a second side surface of the bale;
a second funnel and air nozzle carrying assembly comprising a second lower chassis defining a second sample conduit opening and a second upper nozzle carrying arm;
wherein the second air nozzle is secured to and supported by the second upper nozzle carrying arm; and,
an air vacuum fluidly connected to the second sample intake conduit opening whereby a cotton sample dislodged from the second side surface of bale of cotton can be sucked into the second sample intake conduit.

19. The apparatus of claim 7 further comprising a second air nozzle adjacent a second side surface of the bale.

20. The apparatus of claim 7 further comprising a second air nozzle adjacent the side surface of the bale.
